(19) United States
(12) Patent Application Publication
(10) Pub. No.: US 2013/0221802 A1
(43) Pub. Date: Aug. 29, 2013

(54) POWER GENERATING MODULE AND MOBILE DEVICE HAVING THE SAME

(71) Applicant: Pantech Co., Ltd., (US)

(72) Inventor: Jin Seok OH, Seoul (KR)

(73) Assignee: Pantech Co., Ltd., Seoul (KR)

(21) Appl. No.: 13/706,796

(22) Filed: Dec. 6, 2012

(30) Foreign Application Priority Data
Feb. 23, 2012 (KR) 10-2012-0018339

(51) Int. Cl. H02N 2/18

(52) U.S. Cl. 310/319; 310/339

(57) ABSTRACT

A power generating module includes a multipiezoelectric channel unit including a plurality of rods connected to a frame, the rods including a piezoelectric material to generate a voltage in response to a physical force; and a weight disposed to be supported by the plurality of rods and to move in response to the physical force. A mobile electronic device includes a power generating module including a plurality of channels to convert a physical force applied to the mobile electronic device into electricity; and a logic unit connected to the power generating module to output power using the converted energy.

### CROSS-REFERENCE TO RELATED APPLICATION

This application claims priority from and the benefit under 35 U.S.C. §119(a) of Korean Patent Application No. 10-2012-0018339, filed on Feb. 23, 2012, the entire disclosure of which is incorporated herein by reference for all purposes.

### BACKGROUND

1. Field

The following description relates to a power generating module and a mobile electronic device having the same, and more particularly, to a self-power generating module using a Micro-Electro-Mechanical System (MEMS) and a mobile electronic device having the same.

2. Discussion of the Background

Micro-Electro-Mechanical System (MEMS) may refer to a technology, which may make an ultrafine mechanical structure by processing silicon, quartz, glass or the like. MEMS may also be referred to as a micro machining or micro system.

The MEMS may allow mass production of subminiature products at a low cost by applying a semiconductor microfabrication technology, which may structurally repeat a deposition operation, an etching operation, or the like. The importance of MEMS may be increasing with respect to time along with introduction of nanotechnologies and system-on-chip (SoC) technologies.

The MEMS may be a technology of some importance in the 21^{st} century. Further, applications of the MEMS may be rapidly spreading over various industries, such as an accelerator sensor of a vehicle airbag, or an inkjet printer head. Further, MEMS may be applied to medical fields, such as manufacturing of a biochip for bio-information decoding, a wireless network field, an optical technology field, micromachining technology field or the like.

However, environmental problems became more serious due to exhaustion of fossil fuels and a resultant rise of energy price, more particularly, the exhaust of green-house gases of fossil fuels. Further, securing a new source of clean energy also became a national concern. Therefore, various attempts have been made to generate new regeneration energy, improve energy efficiency and secure future energy resources, which may be stably supplied without damaging the environments.

Among them, energy harvesting as a new regeneration energy source has received focus. Energy harvesting may refer to regeneration of energy by harvesting or scavenging energy that has been consumed or unutilized. If environmental energy around devices or natural energy, such as sun and wind is collected, power may be obtained in the level of several microwatts (uW) to several milliwatts (mW).

The energy harvesting technology may be regarded as a regeneration-type energy source, which may absorb or capture energy occurring in the nature or byproducts of expended energy, such as low-temperature waste heat energy from human bodies or combustion-type engines, micro vibration energy of devices loaded on or attached to portable equipment, dissipation energy generated by physical activities (e.g., walking or running) of human or the like, converts the absorbed energy into electric energy by using the energy harvesting element technology. The converted electric energy may be used to power an electronic device.

Energy harvesters in which the MEMS and the energy harvesting are combined have been actively studied, but an energy harvester used may have a spiral structure having one path where a single channel may be used to generate electric energy. Therefore, the energy harvester may be capable of generating power from external physical energy, but the generated voltage is several ten millivolts (mV), which may be less than the several volts (V) required for a mobile device.

In addition, with respect to a piezoelectric power generation technology using oscillation of regular amplitude, a specific frequency introduced from the outside may cause a harmonic, which may cause damage to the power generating equipment. Accordingly, in order to generate stable electric energy using the above spiral structure, stable physical movement of each channel needs to be ensured by using a vibration film and a piezoelectric film over a certain thickness. Thus, it may be difficult to have a thin design to utilize the piezoelectric power generation technology.

### SUMMARY

Exemplary embodiments of the present invention provide a power generating module and a mobile electronic device having the same.

Additional features of the invention will be set forth in the description which follows, and in part will be apparent from the description, or may be learned by practice of the invention.

Exemplary embodiments of the present invention provide a power generating module including a multipiezoelectric channel unit including a plurality of rods connected to a frame, the rods including a piezoelectric material to generate a voltage in response to a physical force; and a weight disposed to be supported by the plurality of rods and to move in response to the physical force.

Exemplary embodiments of the present invention provide a power generating module including a multipiezoelectric channel unit including a plurality of rods connected to a frame, the rods including a piezoelectric material to generate a voltage in response to a physical force; a weight disposed to be supported by the plurality of rods and to move in response to the physical force; a buffering unit to reduce a frictional force between the weight and the multipiezoelectric channel unit; and a first protecting unit disposed on a first surface of the multipiezoelectric channel.

Exemplary embodiments of the present invention provide a mobile electronic device including a power generating module including a plurality of channels to convert a physical force applied to the mobile electronic device into electricity; and a logic unit connected to the power generating module to output power using the converted energy.

Exemplary embodiments of the present invention provide a mobile electronic device including a power generating module including a plurality of channels to convert an applied force on the mobile electronic device into energy; a charging unit to supply energy output from the power generating module to a battery unit; the battery unit to store the generated energy; and a protecting circuit to open a charging path when energy overage is detected.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 provides a cross-sectional view illustrating a power generating module according to an exemplary embodiment of the present invention.

FIG. 2 provides a plan view illustrating the power generating module of FIG. 1.

FIG. 3 provides various views illustrating a weight employed in a power generating module according to an exemplary embodiment of the present invention.

FIG. 4 provides a conceptual view illustrating a physical movement of a multipiezoelectric channel unit employed in a power generating module according to an exemplary embodiment of the present invention.

FIG. 5 provides cross-sectional views illustrating a protecting unit of a power generating module according to an exemplary embodiment of the present invention.

FIG. 6 provides a cross-sectional view illustrating a power generating module according to an exemplary embodiment of the present invention.

FIG. 7 provides various views illustrating a weight employed in a power generating module according to an exemplary embodiment of the present invention.

FIG. 8 provides various views illustrating multipiezoelectric channel unit employed in a power generating module according to an exemplary embodiment of the present invention.

FIG. 9 provides various views illustrating a protecting unit employed in a power generating module according to an exemplary embodiment of the present invention.

FIG. 10 provides an internal block diagram illustrating a mobile electronic device including a power generating module according to an exemplary embodiment of the present invention.

FIG. 11 provides an internal block diagram illustrating a mobile electronic device including a power generating module according to an exemplary embodiment of the present invention.

FIG. 12 provides an internal block diagram illustrating a mobile electronic device including a power generating module according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

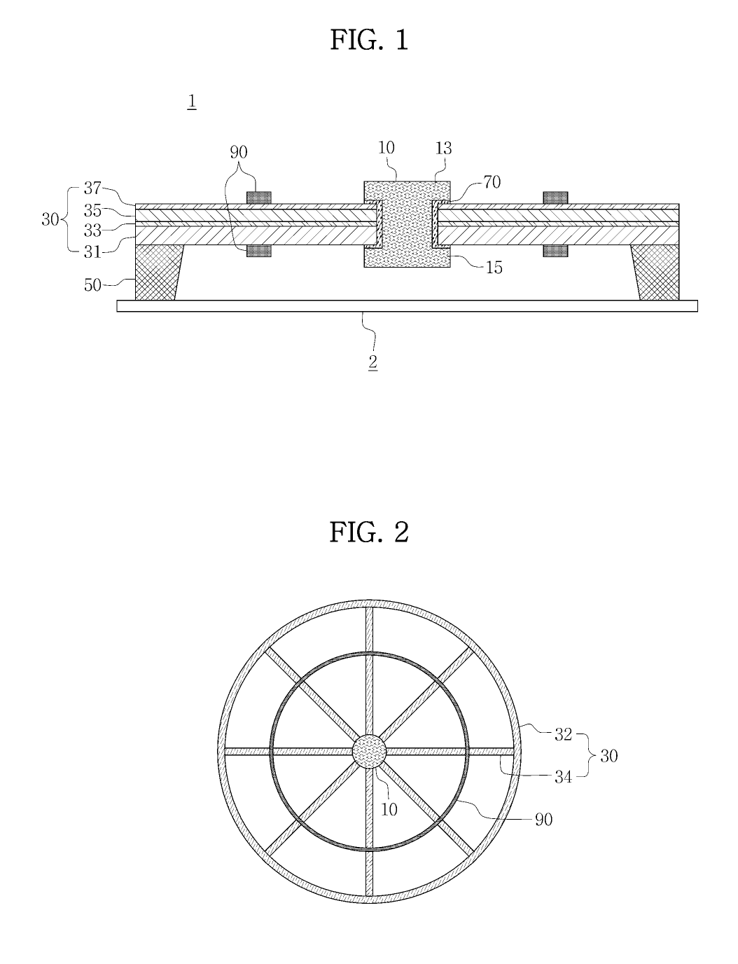

FIG. 1 is a cross-sectional view illustrating a power generating module according to an exemplary embodiment of the present invention. FIG. 2 is a plane view illustrating the power generating module of FIG. 1.

A power generating module of a mobile electronic device based on an energy harvesting operation using a Micro-Electro-Mechanical System (MEMS), and a charger and a battery pack having the same will be described in more detail below. In an example, the power generating module may be a self-power generating module.

Referring to FIG. 1 and FIG. 2, a power generating module 1 includes a weight 10, a multipiezoelectric channel unit 30, and a support unit 50. The power generating module 1 may further include a buffering unit 70 and/or a protecting unit 90.

The power generating module 1 may be disposed in a mobile electronic device 2. The mobile electronic device 2 may include, without limitation, for example, various types of portable electronic devices with a power source, such as a smart phone, a tablet computer, a netbook, a personal digital assistant (PDA), a portable media player (PMP), a PlayStation® Portable (PSP), a Motion Picture Experts Group Audio Layer III (MP3) players, e-book readers, navigators, digital cameras, electronic dictionaries, and electronic clocks.

The weight 10 may be a type of weight used to convert an external force into kinetic energy by making a physical movement with a force transferred from the outside. The weight 10 may be located at a central region of the power generating module 1 and, if a force is applied from the outside, the weight 10 may repeatedly move in a direction of the applied force and in a direction opposite thereto. The multipiezoelectric channel unit 30 may be arranged in a radial shape around the weight 10, but is not limited thereto, such that the piezoelectric channel unit 30 may be arranged in a square shape or other geometric shape. Further, the kinetic energy of the weight 10 may be transferred to the multipiezoelectric channel unit 30.

Referring to FIG. 1 and FIG. 2, the weight 10 may be centrally located within the multipiezoelectric channel unit 30, which may include a plurality of rods extending from the weight 10. The support unit 50 is disposed at a bottom portion of the outer edges of the multipiezoelectric channel unit 30. A plurality of protecting units 90 may be disposed around the weight 10 in a radial manner. The protecting units 90 are disposed on both a first surface and a second surface of the multipiezoelectric channel unit 30. The protecting units 90 are vertically aligned to one another, but are not limited thereto. Further, the protecting units 90 may be disposed at various locations on the surface of the multipiezoelectric channel unit 30, and may have a different geometric shape than the multipiezoelectric channel unit 30.

One or more of the rods of the multipiezoelectric channel unit 30 includes multiple layers of various materials, including, without limitation, a base 31, a first electrode 33, a piezoelectric film 35, and a second electrode 37. Referring to FIG. 1, the base 31 is disposed at a lower portion of the rod, with the first electrode 31 disposed over the base 31. The piezoelectric film 35 is disposed over the first electrode 31, and the second electrode 37 is disposed over the piezoelectric film 35. However, aspects of the invention are not limited thereto, such that the respective elements may be disposed in a different order.

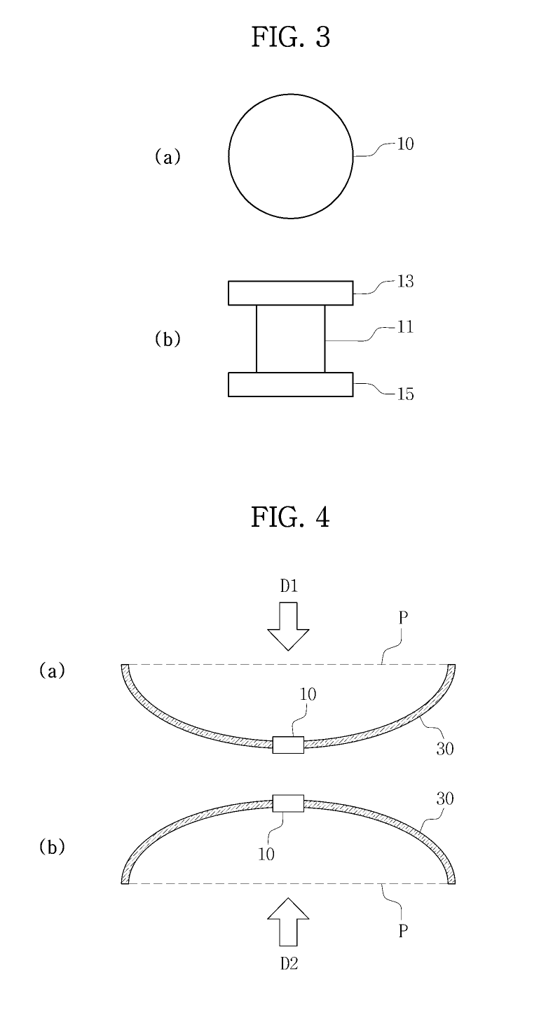

FIG. 3 provides various views illustrating a weight employed in a power generating module according to an exemplary embodiment of the present invention.

Referring to FIG. 3a and FIG. 3b, the weight 10 includes a pillar unit 11 having a side surface, which may partially contact the multipiezoelectric channel unit 30, and an upper surface 13 and a lower surface 15, which may partially contact an upper surface and a lower surface of the multipiezoelectric channel unit 30. The upper surface 13 may be a first end portion of the weight 10, and the lower surface 15 may be a second end portion of the weight 10. The upper surface 13 and the lower surface 15 may be wider than the pillar unit 11 to be secured on the multipiezoelectric channel unit 30. However, aspects of the invention are not limited thereto, such that at least one of the pillar unit 11, the upper surface 13, and the lower surface 15 may not contact the multipiezoelectric channel unit 30. Further, the weight 10 may include only the pillar unit 11 or one of the upper surface 13 or the lower surface 15.

The planar shape of the weight 10 may be circular as illustrated in (a) of FIG. 3, and the cross-section of the weight 10 in a length direction may have a shape of a capital letter “I” as illustrated in (b) of FIG. 3. The pillar unit 11 may have a cylindrical shape, and the upper surface 13 and the lower surface 15 may have a cylindrical shape having the same center as the pillar unit 11. The upper surface 13 and the lower surface 15 may have a greater diameter than the pillar unit 11. However, aspects of the invention are not limited thereto, such that the weight 10 may have other geometrical shapes, including a shape with multiple sides, such as a pentagon, hexagon, octagon, decagon, and the like.

Referring again to FIG. 1 and FIG. 2, since the multipiezoelectric channel unit 30 may be formed to contact the side surface of the weight 10, the power generating module 1 may be able to provide a slim design, and kinetic energy above a reference threshold may be transferred to the multipiezoelectric channel unit 30. However, the shape of the weight 10 is not limited thereto, but may have various modifications according to the number and shape of the multipiezoelectric channel unit 30.

The multipiezoelectric channel unit 30 may be formed in a radial shape around the weight 10, and the multipiezoelectric channel unit 30 of a radial shape may form a multi-channel structure to convert the kinetic energy transferred from the weight 10 into electric energy. The multipiezoelectric channel unit 30 includes a plurality of rods 34 radially extending from the weight 10. More specifically, each rod may have one end coupled or connected to a portion of the weight 10 and the other end coupled or connected to a portion of a ring-shaped frame 32, which may be radially formed or arranged around the weight 10. The multipiezoelectric channel unit 30 may have at least two rods 34.

Since the plurality of rods 34 have ends respectively coupled to the weight 10 and the ring-shaped frame 32, the displacement of physical movement of the weight 10 may be shorter than a conventional design or a reference threshold, which may lower the probability of an incurrence of a harmonic. However, aspects of the invention are limited thereto, such that the ring-shaped frame 32 need not be ring-shaped, such that it may have a square shape, a pentagonal shape, a polygonal shape, and the like. Further, the plurality of rods need not be linear or straight, and may intersect with one another or other components, and may have other patterns in addition to just a radial pattern.

The plurality of rods 34 may form a multi-channel to generate electric energy. The plurality of rods 34 may be configured with piezoelectric elements and may be compressed in a bending direction corresponding to a physical movement of the mobile electronic device including the multipiezoelectric channel unit 30, thereby causing a polarization phenomenon.

The piezoelectric element may generate a voltage due, at least in part, to the polarization phenomenon in a material when a physical pressure is applied thereto. The material may include, for example, quartz, Rochelle salt, barium titanate (BaTiO₃), artificial ceramic (PZT) or the like. Positive (+) charges and negative (−) charges may be generated due to the polarization phenomenon, and the positive (+) charges and the negative (−) charges may move in opposite directions to generate a potential difference.

The plurality of rods 34 may have a similar or the same length. Since the plurality of rods 34 has the same length, the plurality of rods 34 may output a similar or the same voltage and current. Referring again to FIG. 2, when eight rods 34 are present, eight rods may generate a similar or the same electric energy. This will be described below in more detail. However, aspects of the invention are not limited thereto, such that the plurality of rods 34 may have different lengths or made of different materials to provide a different voltage and/or current.

For example, if a user having the mobile electronic device 2 moves the mobile electronic device 2 by a physical motion, such as walking or running, the weight 10 of the power generating module 1 may make a movement, such as a vertical movement, based on the external force. Accordingly, as the kinetic energy of the weight 10 is transferred to the multipiezoelectric channel unit 30, the multipiezoelectric channel unit 30 may make a movement based on FIG. 1.

As shown in (a) of FIG. 4, if a force is applied to the weight 10 in a first direction D1, the weight 10 moves from a reference axis P to a location illustrated in (a) of FIG. 4 in the first direction D1. According to the movement of the weight 10, the multipiezoelectric channel unit 30 may be bent to apply a compression force in the first direction D1.

Similarly, as shown in (b) of FIG. 4, if a force is applied to the weight 10 in a second direction D2, which may be opposite to the first direction D1, the weight 10 moves from a reference axis P to a location illustrated in (b) of FIG. 4 in the second direction D2. According to the movement of the weight 10, the multipiezoelectric channel unit 30 may be bent to apply a compression force in the second direction D2.

The rod 34 may include a base 31, a first electrode 33 and a second electrode 37 formed on the base 31, and a piezoelectric film 35 formed between the first electrode 33 and the second electrode 37.

The base 31 may be formed with an oxide semiconductor, which may include silicon dioxide (SiO₂), for example. As the base 31 is formed with an oxide semiconductor, the structures may be formed on the base 31 using the MEMS.

The piezoelectric film 35 may be a piezoelectric element and may generate electric energy when being compressed in a bending direction due to a vertical movement. For example, the base 31 may have a thickness of about 20 micrometer (um), and the piezoelectric film 35 may have a thickness of about 10 um.

If the weight 10 receives a force, the rod 34 may generate electric energy by a movement. The movement may include a vertical movement, but is not limited thereto. The rod 34 may generates more electric energy at a portion closer to the weight 10 since a displacement may be greater thereat. Further, at a portion of the rod 34 that may be further away from the weight 10, the generated electric energy may decrease since the displacement may become smaller.

Referring again to FIG. 1, the first electrode 33 and the second electrode 37 are respectively formed on an upper surface and a lower surface of the piezoelectric film 35. The first electrode 33 and the second electrode 37 may respectively be any one of a positive (+) terminal and a negative (−) terminal, and may provide a flow path for the electric energy generated by the piezoelectric film 35.

The first electrode 33 and the second electrode 37 may include, without limitation, at least one of platinum (Pt), titanium (Ti), and silver (Ag). For example, the first electrode 33 may be formed with silver (Ag), and the second electrode 37 may include platinum (Pt) or titanium (Ti).

The base 31, the first electrode 33, the piezoelectric film 35, and the second electrode 37 of the rod 34 may be laminated in order and may have the same shape or a shape correspond to the other components. The ring-shaped frame 32 may have the same laminated structure as the rod 34 for convenient production, but is not limited thereto.

The support unit 50 may support the weight 10 and the multipiezoelectric channel unit 30. The support unit 50 may allow the weight 10 and/or the multipiezoelectric channel unit 30 to move while maintaining a reference distance from the mobile electronic device 2. The support unit 50 may be formed with silicon. However, aspects of the invention are not limited thereto, such that the support unit 50 may be formed of various elements.

The support unit 50 may be formed with a ring shape below the ring-shaped frame 32 to correspond to the ring-shaped frame 32 of the multipiezoelectric channel unit 30. Further, the support unit 50 may be formed with a pillar shape below the ring-shaped frame 32 so as to partially correspond to the ring-shaped frame 32. However, without being limited thereto, the number and shape of the support unit 50 may be modified according to design or use.

The buffering unit 70 may be formed at a portion where the weight 10 contacts the rod 34. The buffering unit 70 may absorb a physical impact. More specifically, the buffering unit 70 may prevent or reduce the likelihood of the weight 10 and the rod 34 from being impacted due to excessive movement, and from being damaged by the impact. In addition, the buffering unit 70 may reduce a frictional force between the weight 10 and the multipiezoelectric channel unit 30, which may allow easier junction between them.

The protecting unit 90 may be disposed on a surface of the multipiezoelectric channel unit 30 to enhance a physical strength of the multipiezoelectric channel unit 30. The protecting unit 90 may prevent or reduce the likelihood of the multipiezoelectric channel unit 30 from being damaged due, at least in part, to oscillation generated by a movement of the weight 10. Further, multiple protecting units 90 may be disposed at various surfaces, including a top surface and a bottom surface, of the multipiezoelectric channel unit 30. The multiple protecting units 90 may be disposed at a top surface and a bottom surface of the multipiezoelectric channel unit 30 to be vertically aligned, or staggered between the two surfaces.

Referring to FIG. 2 again, the protecting unit 90 may be formed in a ring shape and disposed around the weight 10. The protecting unit 90 may form a concentric circle having the same center as the ring-shaped frame 32 and the weight 10. Further, the protecting unit 90 may be formed spaced apart from the frame 32 and the weight 10 at a predetermined interval. The protecting unit 90 may be formed to contact at least one of the upper surface and the lower surface of the multipiezoelectric channel unit 30, and the number of the protecting unit 90 may be one or more.

As shown in FIG. 1, the protecting unit 90 may be disposed to contact both the upper surface and the lower surface of the rod 34. In FIG. 1, the protecting units 90 respectively formed at the upper surface and the lower surface of the rod 34 are vertically aligned to each other. However, aspects of the invention are not limited thereto, such that the protecting units 90 may have ring shapes with different radii around the weight 10.

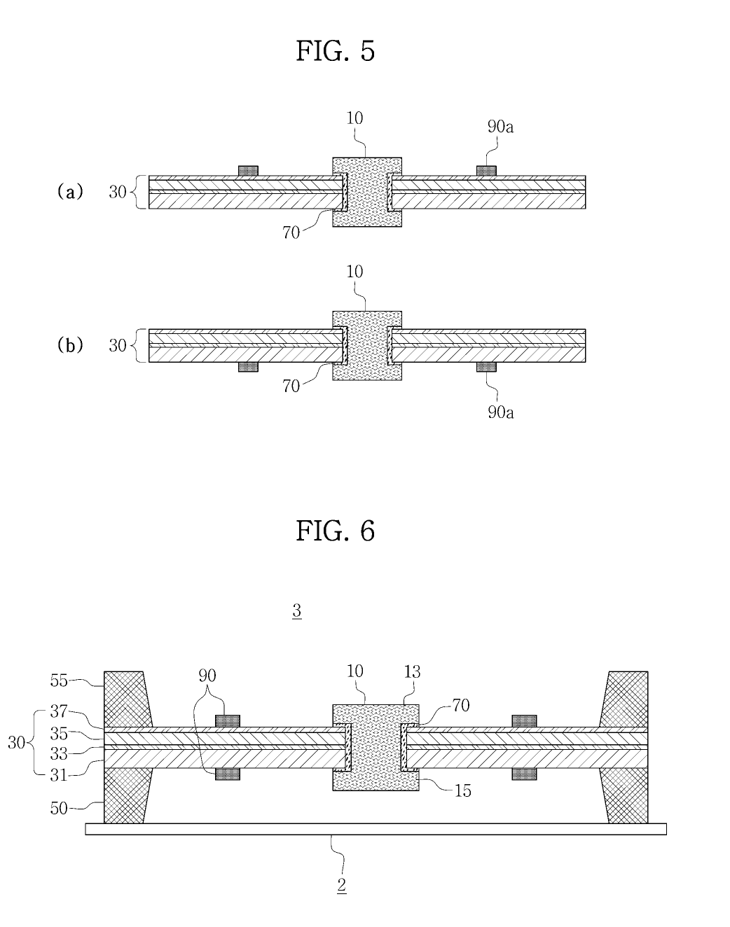

FIG. 5 provides cross-sectional views illustrating a protecting unit of a power generating module according to an exemplary embodiment of the present invention.

As shown in (a) of FIG. 5, the protecting unit 90a may be formed to contact only the upper surface of the rod 34. Also, as shown in (b) of FIG. 5, the protecting unit 90b may be formed to contact only the lower surface of the rod 34.

The power generating module 1 may include the multipiezoelectric channel unit 30 including the rod 34. According to exemplary embodiments, the rods 34 may include piezoelectric material, which may generate a voltage in response to a physical force. Thus, as electric energy is generated at multiple channels via the multipiezoelectric channel unit 30, an output voltage may be enhanced and the possibility of damage caused by oscillation may be reduced.

In addition, the generated kinetic energy may be transferred to the multipiezoelectric channel unit 30 according to the shape of the weight 10, and the power generating module 1 may have a slim design. Further, the physical strength of the power generating module 1 may be further enhanced by adding the buffering unit 70 or the protecting unit 90.

FIG. 6 provides a cross-sectional view illustrating a power generating module according to an exemplary embodiment of the present invention.

Referring to FIG. 6, the power generating module 3 may be substantially identical to the power generating module 1 of FIG. 1, with an exception of at least an auxiliary support unit 55. Therefore, the same element as in the power generating module 1 of FIG. 1 and FIG. 2 may be indicated by the same reference numerical designations and not described in further detail here.

The power generating module 3 further includes an auxiliary support unit 55 to enhance the physical strength of the power generating module 3. The auxiliary support unit 55 may be formed with the same material as the support unit 50 (e.g., silicon) or the same material as the base 31 (e.g., oxide semiconductor). However, aspects of the invention are not limited thereto, such that different elements may be used to form the auxiliary support unit 55.

Referring to FIG. 6, the auxiliary support unit 55 is formed at the upper surface of the multipiezoelectric channel unit 30. The auxiliary support unit 55 is vertically aligned with the support unit 50, but is not limited thereto. The auxiliary support unit 55 may be formed with a ring shape over the ring-shaped frame 32 to be vertically aligned to the ring-shaped frame 32 of the multipiezoelectric channel unit 30. Further, the auxiliary support unit 55 may be formed with a pillar shape above the ring-shaped frame 32 so as to partially overlap the ring-shaped frame 32. However, without being limited thereto, the number and shape of the auxiliary support unit 55 may be modified according to design or use. Further, the auxiliary support may be used to maintain a reference distance from a part of the mobile electronic device 2.

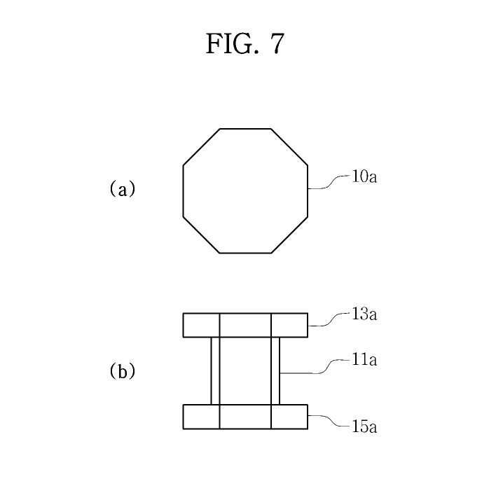

FIG. 7 provides various views illustrating a weight employed in a power generating module according to an exemplary embodiment of the present invention.

The planar shape of the weight 10a may be a regular octagon as illustrated in (a) of FIG. 7, and the cross-section of the weight 10a in a length direction may be formed with a shape of a capital letter “I” as illustrated in (b) of FIG. 7. However, aspects of the invention are not limited thereto, such that the weight 10a may have a shape of a pentagon, hexagon, decagon, and the like.

The pillar unit 1 la may have an octagonal shape, and the upper surface 13a and the lower surface 15a may have a similar octagonal pillar shape having the same center as the pillar unit 11a, but may have a longer apothem. The pillar unit 11a may have a hollow cavity formed therein.

However, the shape of the weight 10a is not limited thereto, and may have various modifications according to the number and shape of the multipiezoelectric channel unit 30. For example, where the multipiezoelectric channel unit 30 has six channels, the upper surface 13a, the lower surface 15a and the pillar unit 11a of the weight 10a may have a cross-section of a hexagonal shape.

Further, where the multipiezoelectric channel unit 30 has eight channels, the pillar unit 11a may have an octagonal shape, but the upper surface 13a and the lower surface 15a may have a cylindrical shape. However, without being limited thereto, the shape of the weight may be modified as according to design or use.

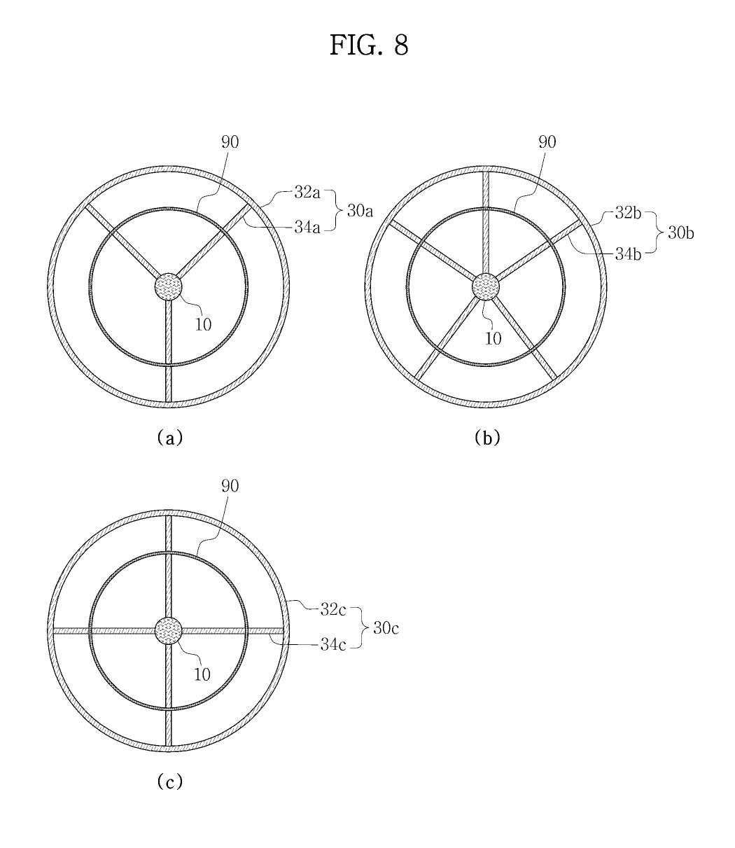

FIG. 8 provides various views illustrating multipiezoelectric channel unit employed in a power generating module according to an exemplary embodiment of the present invention.

Referring to (a) of FIG. 8, (b) of FIG. 8, and (c) of FIG. 8, the multipiezoelectric channel unit 30 may be extended in a radial shape based on a weight 10 from the side surface of the weight, which may be similar or identical to the embodiment of FIG. 1, but with a different number of rods.

More specifically, in (a) of FIG. 8, since three rods 34a are formed, electric energy may be generated at three channels. In (b) of FIG. 8, since five rods 34b are formed, electric energy may be generated at five channels. Similarly, in (c) of FIG. 8, since four rods 34c are formed, electric energy may be generated at four channels.

However, (a) of FIG. 8, (b) of FIG. 8, and (c) of FIG. 8 are provided as examples of the multipiezoelectric channel unit 30, and the sensitivity for external kinetic energy may be adjusted by changing the number or arrangement of rods.

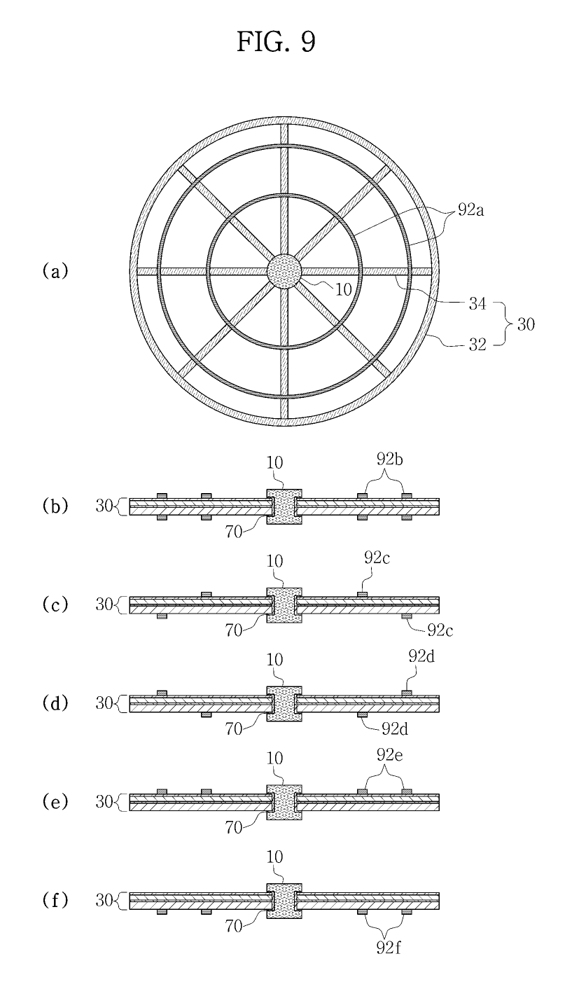

FIG. 9 provides various views illustrating a protecting unit employed in a power generating module according to an exemplary embodiment of the present invention.

Referring to (a) of FIG. 9, two protecting units 92a with different radii may be formed in a ring shape with respect to the weight 10. Referring to (b) of FIG. 9, the protecting unit 92b may have two pairs of ring shapes that are vertically aligned to each other to contact both upper surface and the lower surface of the multipiezoelectric channel unit 30.

In (c) of FIG. 9 and (d) of FIGS. 9, the protecting unit 92c and the protecting unit 92d may be formed with two ring shapes intersecting with each other to contact the upper surface and the lower surface of the multipiezoelectric channel unit 30, respectively. In (e) of FIG. 9 and in (f) of FIG. 9, the protecting unit 92e and the protecting unit 92f may be formed with two ring shape having two different radii to contact only the upper surface or the lower surface of the multipiezoelectric channel unit 30.

However, (a) of FIG. 9, (b) of FIG. 9, (c) of FIG. 9, (d) of FIG. 9, (e) of FIG. 9, and (f) of FIG. 9 are provided as examples of the protecting unit, and the number and shape of the protecting unit may be modified according to design without being limited thereto.

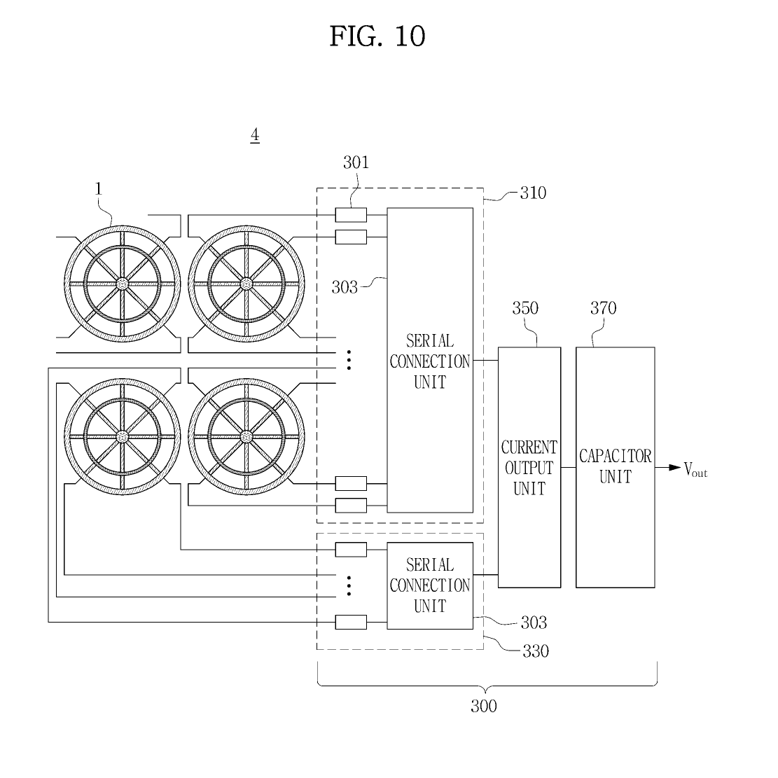

FIG. 10 provides an internal block diagram illustrating a mobile electronic device including the power generating module according to an exemplary embodiment of the present invention.

Referring to FIG. 10, a mobile electronic device 4 includes at least one power generating module 1 and a logic unit 300 connected to the power generating module 1 to output electric energy outputted by the power generating module 1 as a power source.

The power generating module 1 may be similar to at least one of the power generating modules illustrated in FIG. 1, FIG. 2, FIG. 3, FIG. 4, FIG. 5, FIG. 6, FIG. 7, FIG. 8, and FIG. 9 and may not be described in further detail here.

The logic unit 300 may be configured to connect the rods 34 of the power generating module 1 in series or in parallel so that a power above a reference threshold may be output. The logic unit 300 includes at least one voltage output unit 310 and a current output unit 350. The voltage output unit 310 may rectify an Alternate Current (AC) voltage output from the power generating module 1 and output a direct current (DC) voltage. The current output unit 350 may enhance the output current by connecting the output of the voltage output unit 310 in parallel.

The voltage output unit 310 may include a plurality of AC/DC rectifying units 301, which may rectify the AC voltage output from each rod 34 of the multipiezoelectric channel unit 30 into a DC voltage. The AC/DC rectifying unit 301 may be connected to each rod of the multipiezoelectric channel unit 30.

The voltage output unit 310 may be connected to all or a part of the multipiezoelectric channel units 30 of a single power generating module 1. Further, the voltage output unit 310 may be connected to all or a part of the multipiezoelectric channel units 30 of two or more power generating modules 1. Even though FIG. 10 illustrates the voltage output unit 310 and another voltage output unit 330, the aspects of the invention are not limited thereto.

The voltage output unit 310 further includes a serial connection unit 303 to connect output voltages of a plurality of AC/DC rectifying units 301 in series. Here, voltages outputted from the rods 34 of the multipiezoelectric channel units 30 may be connected in series to raise the output voltage. The output voltage may be adjusted from several ten millivolts (mV) to several volts (V) according to design or use. For example, the output voltage may range about 2 V to 5.6 V.

The current output unit 350 may connect voltages outputted from the voltage output units 310 in parallel to raise the output current. The capacity of the capacitor unit 370 may be improved by raising the output current.

The logic unit 300 may further include the capacitor unit 370, which may accumulate electric charges and may provide power storage. The capacitor unit 370 may be formed as an internal capacitor at the logic unit 300 or may be formed as an external capacitor separately from the logic unit 300.

The mobile electronic device 4 may be supplied with stable power even though it includes a single power generating module 1 and an external power is not applied thereto. The mobile electric device 4 may output a target voltage or current according to the design of the voltage output unit 310 and the current output unit 350.

In addition, since the power generating module 1 may use a piezoelectric film with below a reference thickness to provide a smaller design, the mobile electronic device 4 including the power generating module 1 may have a slim and small design.

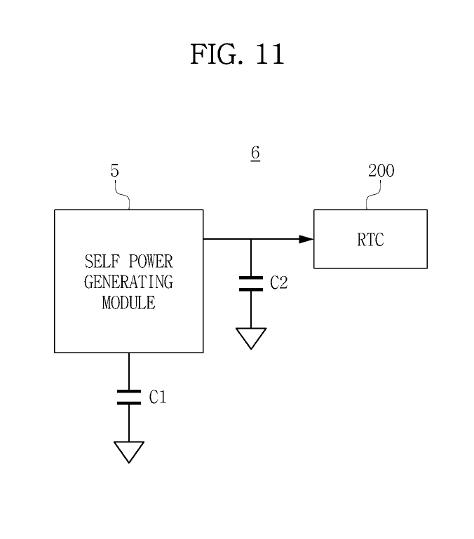

FIG. 11 provides an internal block diagram illustrating a mobile electronic device including a power generating module according to an exemplary embodiment of the present invention.

Referring to FIG. 11, the mobile electronic device 6 may use the power generating module 5 as a charge source of a real time clock (RTC) 200. More specifically, the RTC 200 may be a load component, which may be powered by the power generating module 5.

The first capacitor C1 and the second capacitor C2 may be bypass capacitors, where the first capacitor C1 may be an auxiliary capacitor of the power generating module 5 and the second capacitor C2 may remove noise of an output terminal.

The RTC 200 of a mobile electronic device may be driven by a separate coin-shaped cell including a charging circuit as a secondary battery or a unit battery. A main power source supplied from a battery of the mobile electronic device may be supplied to the charging circuit to charge the coin-shaped battery, and the power may be simultaneously supplied to the

RTC 200. Further, when the main power source is not supplied, the charging circuit may recognize the power-off state of the mobile electronic device and substitutes the power input to the RTC 200 with the coin-shaped battery. However, since the coin-shaped battery may explode if overcharged, a separate integrated circuit (IC) to prevent or reduce the likelihood of explosion may be provided.

On the contrary, the power generating module 5 may allow generation of power. Therefore, where the power generating module 5 is used to drive the RTC 200, a separate battery or charging circuit may not be used, and a mounting area may be reduced. In addition, kinetic energy transferred from an outside source may be converted into electric energy and supplied as a power source without any special capacity limit. Even though there is no kinetic energy transferred from the outside, the power stored in the capacitor unit 370 may be used. Therefore, the power generating module 5 may have a reduced or no limit caused by waiting time.

Even though the power generating module 5 is described as being used to charge the RTC 200 of the mobile electronic device 6, the power generating module 5 may also be used as a main power source or an auxiliary power source of the mobile electronic device 6 or internal components of the mobile electronic device 6.

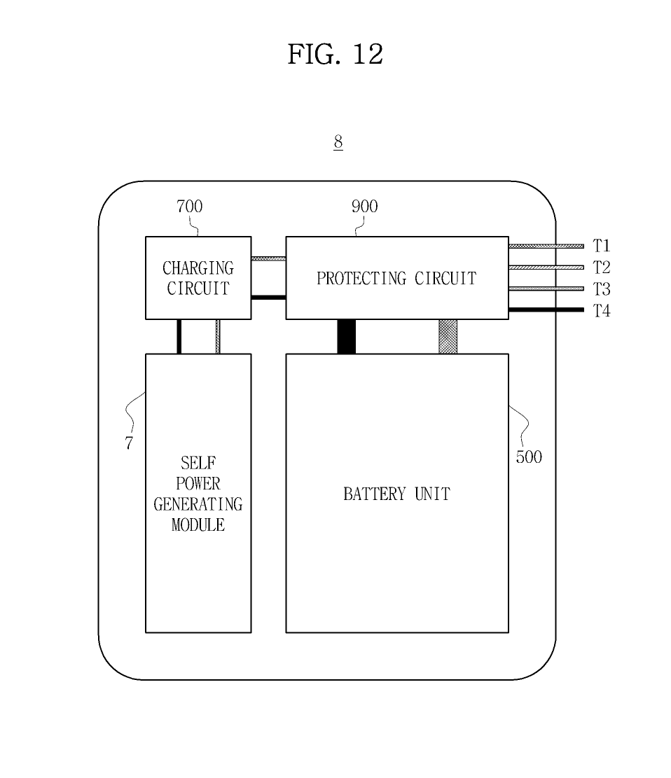

FIG. 12 provides an internal block diagram illustrating a mobile electronic device including a power generating module according to an exemplary embodiment of the present invention.

Referring to FIG. 12, a battery pack of a mobile electronic device 8 may be formed by using the power generating module 7. The mobile electronic device 8 includes a power generating module 7, a battery unit 500 to repeat charging and discharging of power, and a charging circuit 700 to regularly supply the power output from the power generating module 7 to the battery unit 500.

The mobile electronic device 8 may further include a protecting circuit 900 to prevent or reduce a likelihood of the battery unit 500 from being overcharged or overly discharged. The protecting circuit 900 may be referred to as a Protection Circuit Module (PCM) circuit. The protecting circuit 900 may prevent or reduce the likelihood of the battery unit 500 from exploding due to an external electric impact and may protect or extend the life cycle of the battery unit 500.

Terminal T1, terminal T2, terminal T3, and terminal T4 connected to the protecting circuit 900 may be designed and used according to appropriate situation, and, for example, may be used as a positive (+) terminal, a negative (−) terminal, an identification (ID) terminal, and a temperature output terminal. By using the ID terminal, it may be possible to check whether the battery pack is suitable for the mobile electronic device 8.

The protecting circuit 900 may have an Over Voltage Protection (OVP) operation to open a charging path when voltage overage is introduced or detected, and an Over Current Protection (OCP) to open a charging path when a current overage is introduced or detected. In addition, the protecting circuit 900 may have an operation of checking or determining a change of temperature of the battery unit 500 by using a semiconductor element whose electric resistance may vary according to temperature.

The power generating module 7 may be used as a main/auxiliary power source or a main/auxiliary charge source of the mobile electronic device 8 or internal components of the mobile electronic device 8.

According to exemplary embodiments of the present invention, since the power generating module may provide a multi-channel structure for generating electric energy, a voltage above a reference threshold may be generated. In addition, since the structure of the power generating module may provide some protection or resistance against oscillation caused by a harmonic generated by the introduction of excessive external kinetic energy or frequency, the power generating module may have a greater physical strength.

Further, since the power generating module may use a piezoelectric film with a thickness below a reference threshold to have a small design, a mobile electronic device including the power generating module may accommodate a slim and small design. In addition, since the power supplied by the power generating module may be used as a charge source or power source, it may be possible to supply stable power even though an external power is not applied.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A power generating module, comprising:
a multipiezoelectric channel unit comprising a plurality of rods connected to a frame, the rods comprising a piezoelectric material to generate a voltage in response to a physical force; and
a weight disposed to be supported by the plurality of rods and to move in response to the physical force.

2. The power generating module of claim 1, wherein at least one of the plurality of rods is connected to a portion of the weight and a portion of the frame to allow a movement of the weight.

3. The power generating module of claim 1, wherein the piezoelectric material generates voltage when a physical pressure is applied thereto.

4. The power generating module of claim 1, wherein the plurality of rods are compressed in a bending direction corresponding to the physical force to generate electricity.

5. The power generating module of claim 1, wherein at least one of the plurality of rods comprises a base material, a first electrode, a second electrode, a piezoelectric electric film.

6. The power generating module of claim 1, wherein the plurality of rods are radially arranged around the weight.

7. The power generating module of claim 1, further comprising:
a support unit disposed on a surface of the multipiezoelectric channel unit to maintain a reference distance between the multipiezoelectric channel unit and a portion of a mobile electronic device, in which the power generating module is comprised.

8. The power generating module of claim 1, wherein the weight has an end portion and a pillar unit, the end portion having a greater diameter than the pillar unit.

9. The power generating module of claim 1, wherein the weight has a planar shape comprising a plurality of sides or a circular shape.

10. The power generating module of claim 1, further comprising:
a first protecting unit disposed on a first surface of the multipiezoelectric channel unit; and
a second protecting unit disposed on a second surface of the multipiezoelectric channel unit,
wherein the first protecting unit and the second protecting unit are vertically aligned.

11. The power generating module of claim 1, further comprising:
a first protecting unit disposed on a first surface of the multipiezoelectric channel unit; and
a second protecting unit disposed on a second surface of the multipiezoelectric channel unit,
wherein the first protecting unit and the second protecting unit are vertically staggered.

12. The power generating module of claim 1, wherein the frame is ring shaped and radially arranged around the weight.

13. A power generating module, comprising:
a multipiezoelectric channel unit comprising a plurality of rods connected to a frame, the rods comprising a piezoelectric material to generate a voltage in response to a physical force;
a weight disposed to be supported by the plurality of rods and to move in response to an external force;
a buffering unit to reduce a frictional force between the weight and the multipiezoelectric channel unit; and
a first protecting unit disposed on a first surface of the multipiezoelectric channel.

14. A mobile electronic device, comprising:
a power generating module comprising a plurality of channels to convert a physical force applied to the mobile electronic device into electricity; and
a logic unit connected to the power generating module to output power using the converted energy.

15. The mobile electronic device of claim 14, wherein the logic unit connects a plurality of rods of the power generating module in series to raise a voltage output.

16. The mobile electronic device of claim 14, wherein the logic unit connects a plurality of rods of the power generating module in parallel to raise a current output.

17. The mobile electronic device of claim 14, wherein the logic unit rectifies an Alternate Current (AC) voltage output from the power generating module and outputs a Direct Current (DC) voltage.

18. The mobile electronic device of claim 14, further comprising:
a load component to be powered at least in part by the power generating module,
wherein the load component comprises a unit battery to store excess power generated by the power generating module.

19. The mobile electronic device of claim 18, wherein the load component is simultaneously powered by a main battery of the mobile electronic device.

20. A mobile electronic device, comprising:
a power generating module comprising a plurality of channels to convert an applied force on the mobile electronic device into energy;
a charging unit to supply energy output from the power generating module to a battery unit;
the battery unit to store the generated energy; and
a protecting circuit to open a charging path when energy overage is detected.
